(19) United States
(12) Patent Application Publication
(10) Pub. No.: US 2026/0255378 A1
(43) Pub. Date: Aug. 27, 2026

(54) INTERFERENCE MITIGATION (IM) PILOT TONE INSERTION IN WIRELESS TRANSMISSIONS

(71) Applicant: NEWRACOM, Inc., Irvine, CA (US)

(72) Inventors: Heejung YU, Daejeon (KR); Joonsoo LEE, Irvine, CA (US); Si-Chan NOH, Seoul (KR); Il-Gu LEE, Seoul (KR)

(73) Assignee: NEWRACOM, Inc., Irvine, CA (US)

(21) Appl. No.: 19/459,518

(22) Filed: Jan. 26, 2026

Related U.S. Application Data
(60) Provisional application No. 63/764,420, filed on Feb. 27, 2025.

(51) Int. Cl. H04W 72/541; H04L 5/00

(52) U.S. Cl. CPC H04W 72/541; H04L 5/0007; H04L 5/0048; H04L 5/0053

(57) ABSTRACT

Disclosed herein is a method performed by a wireless device to insert interference mitigation pilots in a wireless transmission. The method includes mapping data tones of a first tone plan for a first resource unit size to a subset of data tones of a second tone plan for a second resource unit size that is larger than the first resource unit size, assigning remaining data tones of the second tone plan that are not included in the subset of data tones to be interference mitigation pilot tones, and transmitting an orthogonal frequency division multiplexing (OFDM) symbol in a resource unit having the second resource unit size in accordance with the mapping and the assignment.

### CROSS-REFERENCE TO RELATED APPLICATION

This application claims the benefit of U.S. Provisional Application No. 63/764,420, filed Feb. 27, 2025, titled “Interference mitigation (IM) pilot tone insertion method for an IEEE 802.11bn ultra-high reliability (UHR) Wi-Fi standard”, which is hereby incorporated by reference.

### TECHNICAL FIELD

The present disclosure generally relates to wireless communications, and more specifically, relates to inserting interference mitigation pilots in wireless transmissions.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming.

The IEEE 802.11bn (Ultra High Reliability (UHR) or “Wi-Fi 8”) working group has been established to address the growing demand for higher peak throughput and reliability in Wi-Fi. Candidate features for 802.11bn include MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

With the increasing density of wireless networks, interference problems become more severe. To improve the reliability of wireless transmissions, there is a need to mitigate interference. Due to the dynamic nature of interference, performing interference mitigation at the receiver side is a more reasonable approach than performing interference mitigation at the transmitter side. One way to mitigate interference is to perform receive beamforming (RX BF) at the receiver side. To do this, the receiver has to be able to perform real-time (i.e., in the middle of a packet) channel estimation. Additional pilot tones can be assigned to each orthogonal frequency division multiplexing (OFDM) symbol to allow the receiver to perform real-time channel estimation. However, to be able to accommodate the additional pilot tones, the existing transmitter and receiver structures (which are designed to accommodate only a certain number of pilot tones) have to be significantly modified, which increases the implementation complexity.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing a transmitter structure for supporting a tone plan with interference mitigation (IM) pilot tones for a 106 resource unit (RU) size, where the existing tone plan for the 52+26 RU size is reused, according to some embodiments.

FIG. 11 is a diagram showing a tone mapping process for inserting IM pilots, according to some embodiments.

FIG. 12 is a diagram showing a transmitter structure for supporting a tone plan with IM pilots for a 106 RU size with dual carrier modulation (DCM), where the existing tone plan for the 52+26 RU size with DCM is reused, according to some embodiments.

FIG. 13 is a table showing example tone plans with IM pilot tones for different RU sizes, according to some embodiments.

FIG. 14 is a flow diagram showing a method for inserting IM pilots in a wireless transmission, according to some embodiments.

### DETAILED DESCRIPTION

The present disclosure generally relates to wireless communications, and more specifically, relates to inserting interference mitigation pilots in wireless transmissions.

As mentioned above, additional pilot tones can be assigned to each orthogonal frequency division multiplexing (OFDM) symbol to allow a receiver to perform real-time channel estimation. However, to be able to accommodate the additional pilot tones, the existing transmitter and receiver structures (which are designed to accommodate only a certain number of pilot tones) have to be significantly modified, which increases the implementation complexity.

The present disclosure introduces a solution that allows a wireless device to support additional pilot tones without significantly increasing the implementation complexity. The additional pilot tones may help a receiver with mitigating interference (e.g., by allowing the receiver to perform real-time channel estimation) and thus may be referred to herein as interference mitigation (IM) pilot tones. The solution introduces a new functional block that maps data tones of an existing tone plan for particular resource unit size (e.g., a tone plan defined in an Institute of Electrical and Electronics Engineers (IEEE) 802.11 wireless networking standard) to a subset of data tones of another existing tone plan for a larger resource unit size and assigns the remaining data tones of the existing tone plan for the larger resource unit size (that are not included in the subset) to be IM pilot tones. The new functional block may be referred to herein as an IM pilot tone mapper. The IM pilot tone mapper may be situated between a low density parity check code (LDPC) tone mapper and a spatial and frequency mapper. By using the IM pilot tone mapper, IM pilots can be inserted in wireless transmissions while reusing existing tone plans. By reusing existing tone plans, the existing LDPC tone mapper and the existing spatial and frequency mapper (which do not support the IM pilot tones) can be reused without modification, which reduces the implementation complexity of the wireless device (e.g., since there is no need to have a dedicated LDPC tone mapper and spatial and frequency mapper (and potentially other functional blocks) that are designed specifically for tone plans with IM pilot tones). The present disclosure also describes various tone plans with IM pilot tones that can be supported based on reusing existing tone plans.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

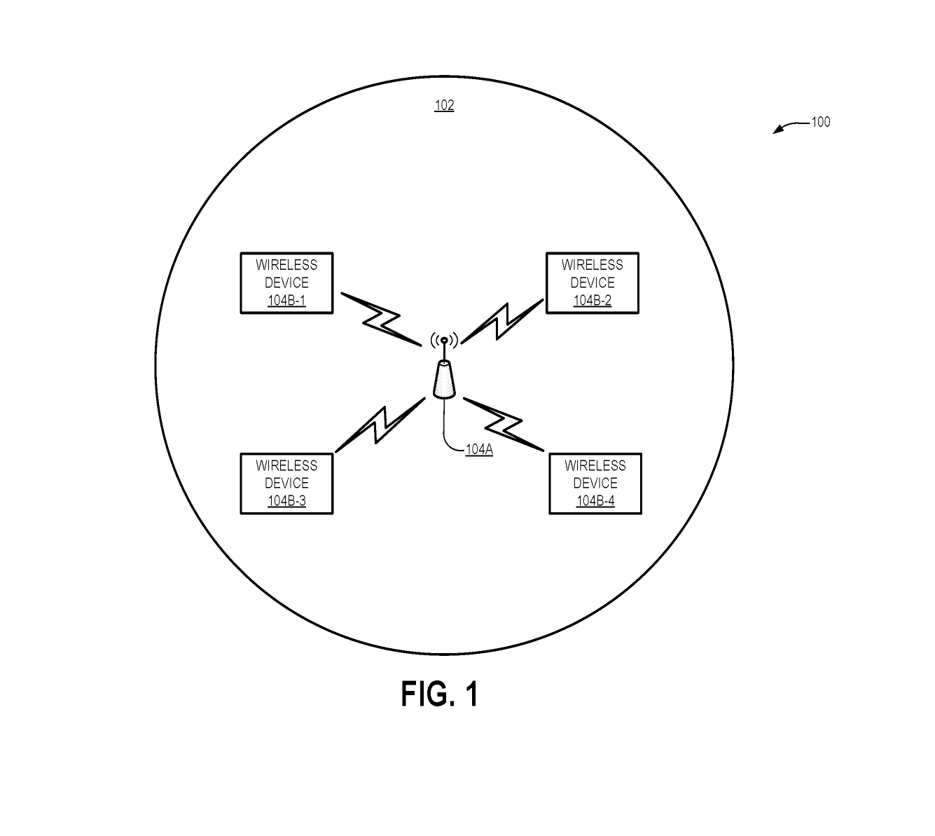

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

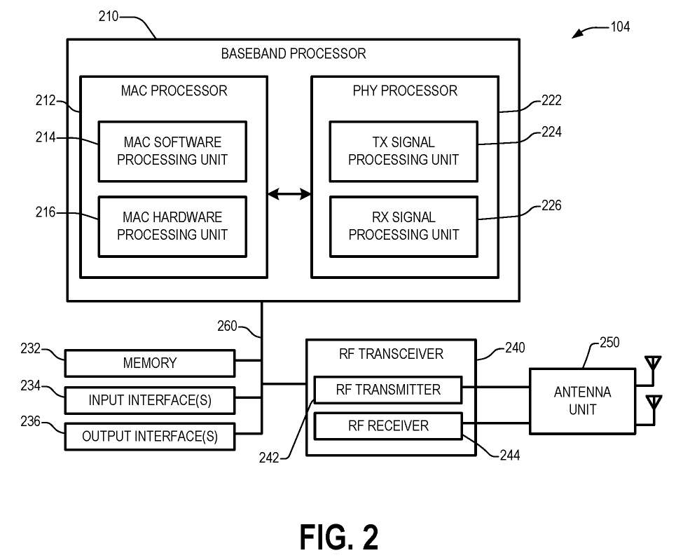

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

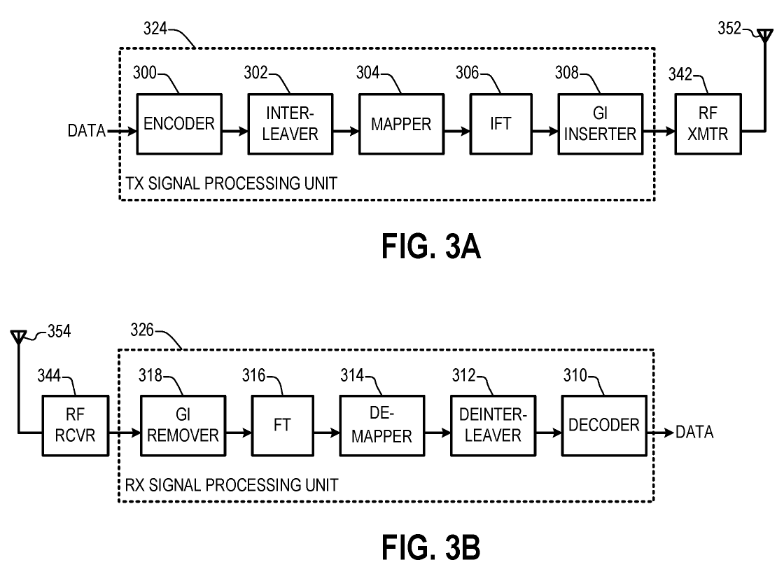

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

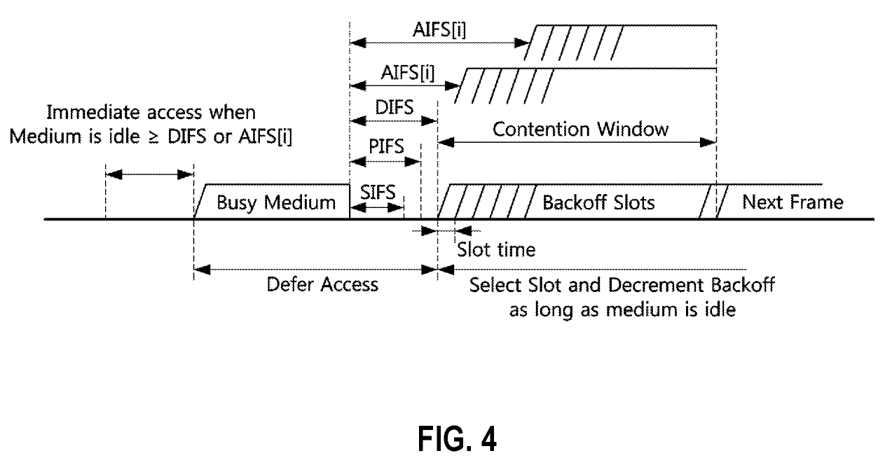

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

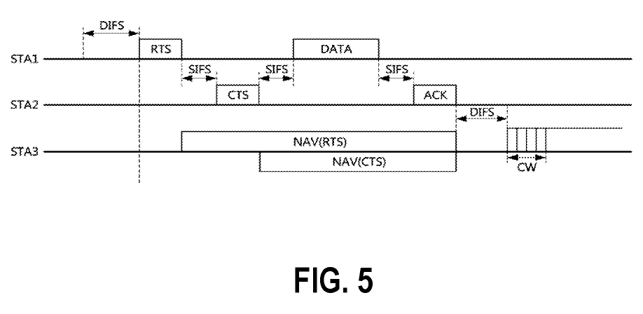

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS + CTS frame duration + SIFS + data frame duration + SIFS + ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

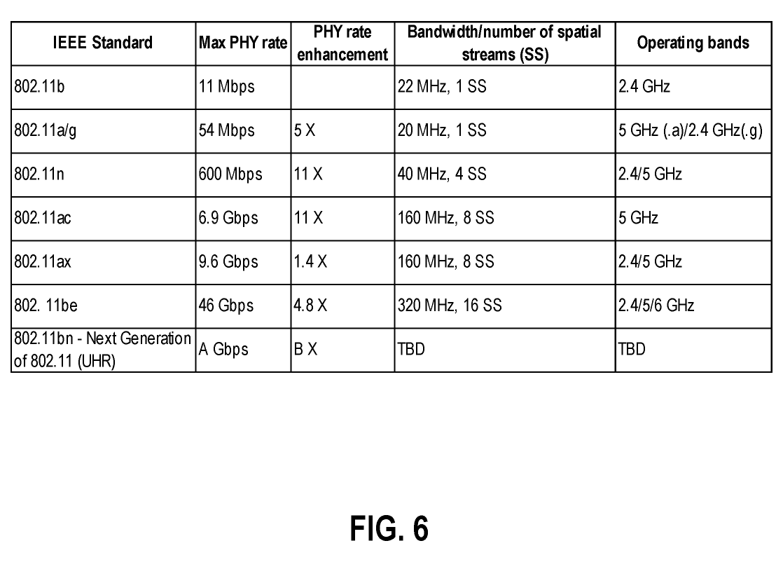

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925– 7.125 GHz) is being considered for unlicensed use. This would allow APs and STAs to become tri-band devices. Larger than 160MHz data transmissions (e.g., 320 MHz or 640 MHz) could be considered to increase the maximum PHY rate. For example, 320 MHz or 160+160MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

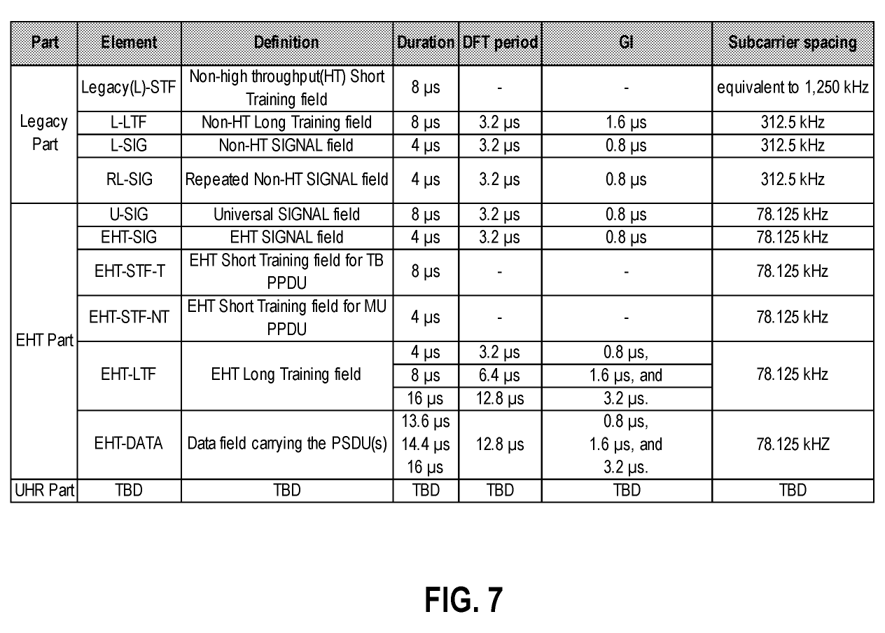

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

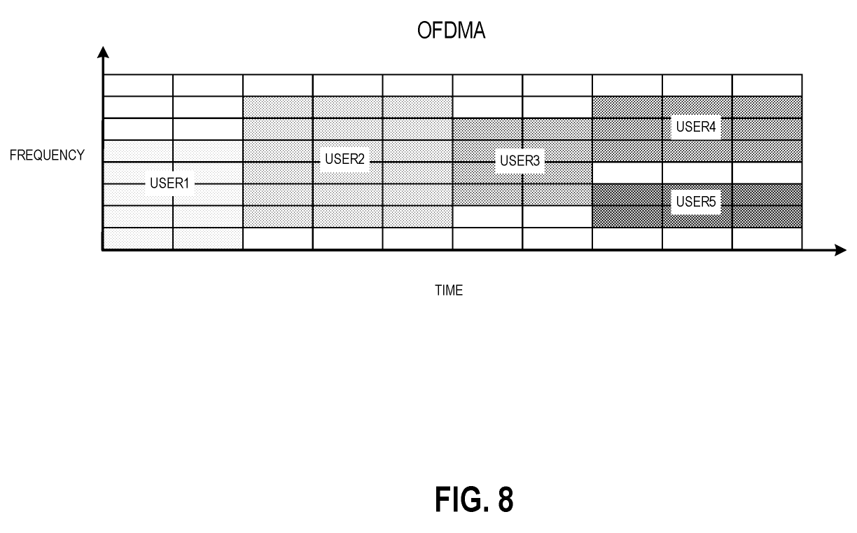

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

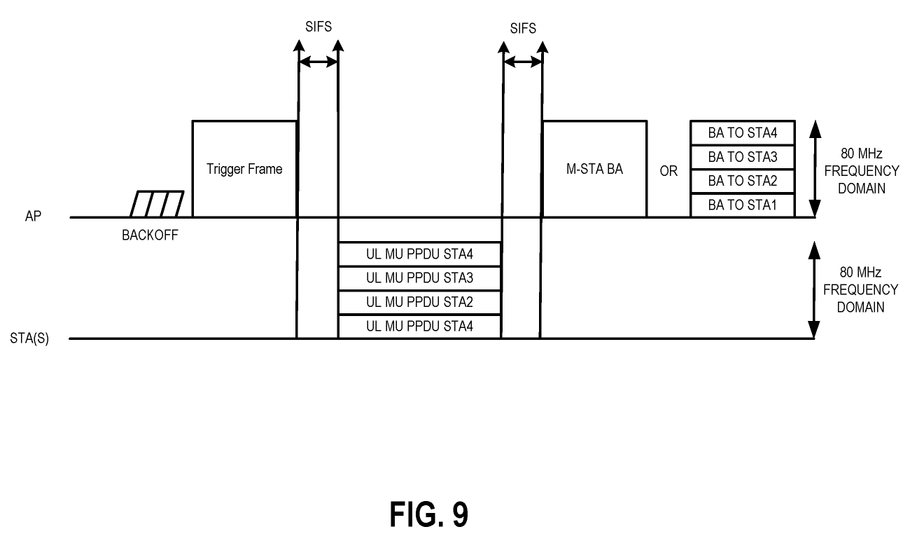

FIG. 9 illustrates an example scenario where an access point (AP) operating in an 80MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

A receive beamforming (RX BF) scheme can be used to mitigate interference at the receiver side. Receive beamforming has several benefits: 1) it is a well-established technology; 2) it can handle interference in any bandwidth (e.g., narrow and wide band interference); and 3) it can handle interference generated in the middle of a packet if a proper channel estimation method is available.

To allow a receiver to estimate the channel state information (CSI) in the middle of a packet, a transmitter may insert known pilot tones, referred to herein as interference mitigation (IM) pilot tones, in each OFDM symbol of the packet. The conventional pilot tones defined in the existing IEEE 802.11 wireless networking standards (which may be referred to herein as “regular” pilot tones to distinguish them from IM pilot tones) are used for phase tracking and accurate frequency and timing synchronization. However, these regular pilot tones are too sparse in the frequency domain to allow the receiver to estimate CSI. That is, the number of regular pilot tones defined in existing tone plans (e.g., tone plans defined by existing IEEE 802.11 wireless networking standards) is not sufficient to estimate CSI at the receiver side.

To be able to accommodate IM pilot tones, the existing transmitter and receiver structures (which are designed to accommodate only a certain number of regular pilot tones) have to be significantly modified, which increases the implementation complexity. To support the addition of IM pilot tones while minimizing the increase in implementation complexity, a solution is described herein that reuses the existing tone plans (which define the number of data tones and the number of regular pilot tones for different resource unit (RU) sizes) defined by existing versions of the IEEE 802.11 wireless networking standards (e.g., the IEEE 802.11be wireless networking standard) so that existing functional blocks that are designed for the existing tone plans can be reused. As will be described in additional detail herein, the solution inserts a new functional block to the transmitter side to insert IM pilots.

As an example, the existing tone plan for the 106 RU size (without IM pilot tones) is defined to have 102 data tones and 4 pilot tones. As used herein, the term “n RU size” refers to a RU size having n tones/subcarriers. To support IM pilot tones, some of the 102 data tones can be used as IM pilot tones (tones that carry IM pilots). For example, 50 data tones out of the 102 data tones can be used as IM pilot tones, while the remaining 52 data tones can continue to be used as data tones. To support this new tone plan (with 52 data tones, 4 regular pilot tones, and 50 IM pilot tones), a new LDPC tone mapper block, padding block, spatial and frequency mapper block, and potentially other functional blocks that are designed specifically for this new tone plan have to be added to the transmitter and receiver structures, which can unduly increase the implementation complexity. It is recognized by the present disclosure that tone plans for the 26 RU size, 52 RU size, and 52+26 RU size are already defined in existing IEEE 802.11 wireless networking standards, and that these tone plans can be reused to support new tone plans with IM pilot tones. The new tone plan with IM pilot tones for the 106 RU size can have the same number of data tones as an existing tone plan for a smaller RU size (e.g., existing tone plan for 26 RU size, 52 RU size, or 52+26 RU size). For example, there can be three possible new tone plans with IM pilot tones for the 106 RU size: 1) a tone plan with 72 data tones, 4 regular pilot tones, and 30 IM pilot tones (in which the existing tone plan for the 52+26 RU size is reused), 2) a tone plan with 48 data tones, 4 regular pilot tones, and 54 IM pilot tones (in which the existing tone plan for the 52 RU size is reused); and 3) a tone plan with 24 data tones, 4 regular pilot tones, and 78 IM pilot tones (in which the existing tone plan for the 26 RU size is reused). The third/last tone plan that reuses the existing tone plan for the 26 RU size might be less preferable because the number of data tones is much lower than the number of IM pilot tones.

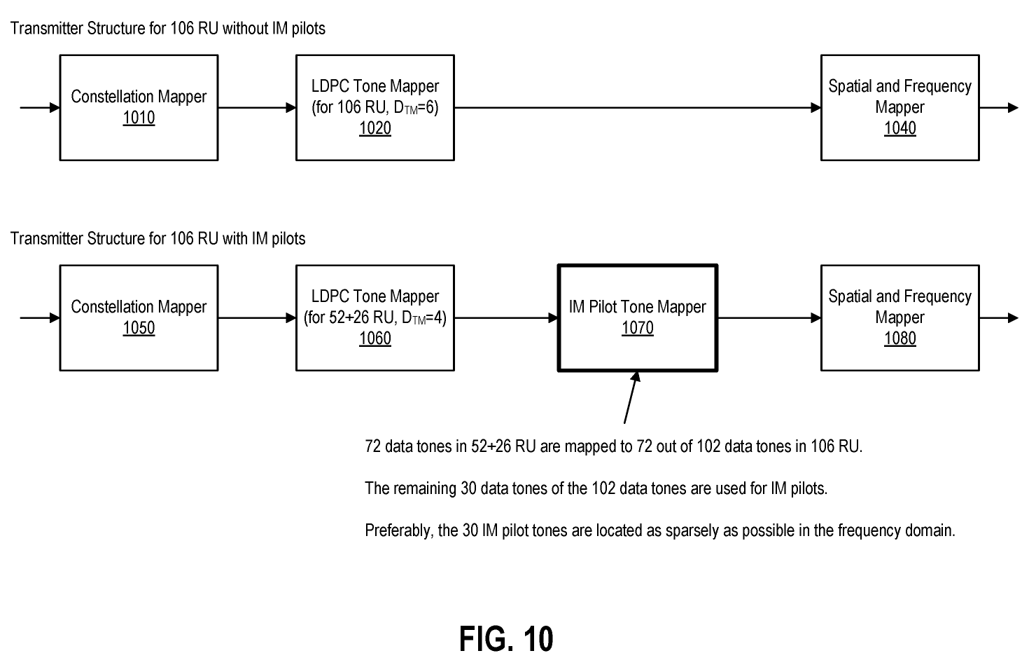

FIG. 10 is a diagram showing a transmitter structure for supporting a tone plan with IM pilot tones for a 106 RU size, where the existing tone plan for the 52+26 RU size is reused, according to some embodiments.

For comparison purposes, the diagram shows both an existing transmitter structure for transmission in a 106 RU size without IM pilots (referred to herein below as the existing transmitter structure) and a new transmitter structure for transmission in a 106 RU size with IM pilots (referred to herein below as the new transmitter structure).

As shown in the diagram, the existing transmitter structure includes a constellation mapper 1010, a LDPC tone mapper 1020, and a spatial and frequency mapper 1040. The constellation mapper 1010 (also referred to as a QAM mapper) may map bits to constellation points (e.g., using BPSK, QPSK, 16-QAM, etc.). The LDPC tone mapper 1020 may apply LDPC tone mapping for a 106 RU size with D_{TM}=6 (where D_{TM} is a tone mapping distance). The spatial and frequency mapper 1040 may map space-time streams to transmit chains (e.g., map N_STS space-time streams to N_TX transmit chains, where N_STS is less than or equal to N_TX). In the IEEE 802.11 wireless networking standard, “Q” matrix operation means spatial mapping. In an embodiment, the spatial and frequency mapper 1040 also performs OFDM tone assignment. For simplicity of explanation, only certain functional blocks are shown in the diagram. It should be appreciated that a transmitter structure can have additional functional blocks.

As shown in the diagram, the new transmitter structure includes a constellation mapper 1050, a LDPC tone mapper 1060, and a spatial and frequency mapper 1080. In addition, the new transmitter structure includes a new functional block referred to herein as the IM pilot tone mapper 1070 that is situated between the LDPC tone mapper 1060 and the spatial and frequency mapper 1080.

The diagram shows an example where the existing tone plan for the 52+26 RU size is reused to transmit an OFDM symbol in a 106 RU size. For example, in the new transmitter structure, the LDPC tone mapper 1060 for the 52+26 RU size and D_{TM}=4 is used instead of the LDPC tone mapper 1020 for the 106 RU size with D_{TM} =6. Although not shown in the diagram, other transmit functional blocks (e.g., spatial and frequency mapping, pre-FEC padding, and/or post-FEC padding functional blocks) for the 52+26 RU size may be reused to support transmission in the 106 RU size with IM pilots.

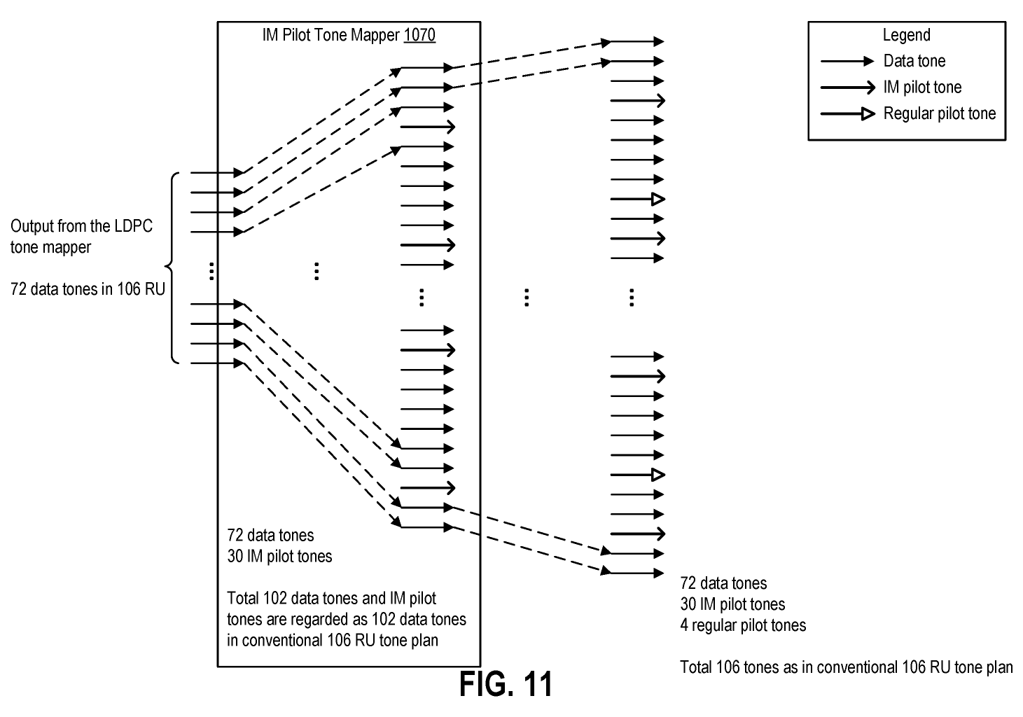

The IM pilot tone mapper 1070 may map the 72 data tones defined in the (existing) tone plan for the 52+26 RU size (which may be the output from the LDPC tone mapper 1020) to 72 data tones out of the 102 data tones defined in the existing tone plan for the 106 RU size. The IM pilot tone mapper 1070 may assign the remaining 30 data tones of the 102 data tones defined in the tone plan for the 106 RU size to be IM pilot tones. The 30 IM pilot tones may be located as sparsely as possible (in the frequency domain) within the 106 RU size. The tone mapping process is shown in more detail in FIG. 11.

FIG. 11 is a diagram showing a tone mapping process for inserting IM pilots, according to some embodiments.

As shown in the diagram, the LDPC tone mapper for the 52+26 RU size may provide 72 data tones to the IM pilot tone mapper 1070. The IM pilot tone mapper 1070 may map these 72 data tones to 72 data tones out of the 102 data tones defined by the existing tone plan for the 106 RU size and assign the 30 remaining data tones to be IM pilot tones. The four (4) regular pilot tones defined by the existing/conventional tone plan for the 106 RU size may continue to be used as regular pilot tones. As a result, a new tone plan with IM pilot tones for the 106 RU size can be defined as having 72 data tones, 30 IM pilot tones, and 4 regular pilot tones. The mapping provided by the IM pilot tone mapper 1070 allows for reusing existing tone plans (the existing tone plan for the 52+26 RU size in this example) to support tone plans with IM pilots. By reusing existing tone plans, already existing functional blocks (the LDPC tone mapper 1060 for the 52+26 RU size) can be reused without modification and there is no need to add separate functional blocks (e.g., LDPC tone mappers) designed specifically for the tone plan with IM pilot tones, thereby reducing implementation complexity.

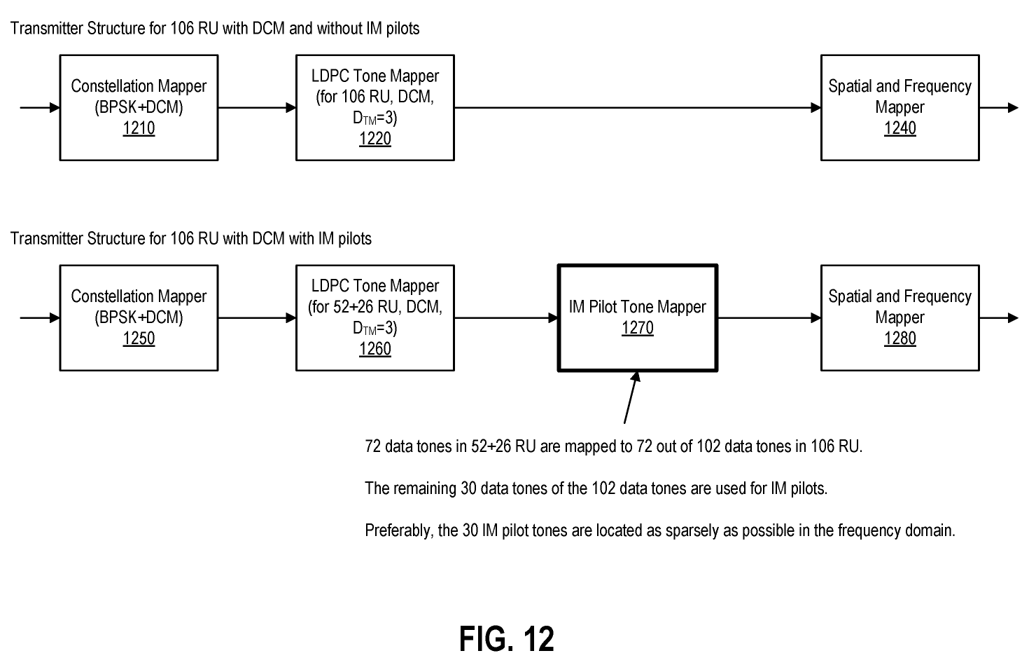

Dual carrier modulation (DCM) is a modulation technique that enhances data transmission reliability by duplicating the same information across two different tones/subcarriers. When DCM is applied in the 106 RU size, the transmitter structure may be modified as shown in FIG. 12.

FIG. 12 is a diagram showing a transmitter structure for supporting a tone plan with IM pilots for a 106 RU size with DCM, where the existing tone plan for the 52+26 RU size with DCM is reused, according to some embodiments.

For comparison purposes, the diagram shows both an existing transmitter structure for transmission in a 106 RU size with DCM without IM pilots (referred to herein below as the existing transmitter structure) and a new transmitter structure for transmission in a 106 RU size with DCM with IM pilots (referred to herein below as the new transmitter structure).

As shown in the diagram, the existing transmitter structure includes a constellation mapper 1210, a LDPC tone mapper 1220, and a spatial and frequency mapper 1240. The constellation mapper 1210 may map bits to constellation points using DCM (e.g., binary phase shift keying (BPSK) with DCM). The LDPC tone mapper 1220 may apply LDPC tone mapping for a 106 RU size with DCM with D_{TM}=3. The spatial and frequency mapper 1240 may map space-time streams to transmit chains.. For simplicity of explanation, only certain functional blocks are shown in the diagram. It should be appreciated that a transmitter structure can have additional functional blocks.

As shown in the diagram, the new transmitter structure includes a constellation mapper 1250, a LDPC tone mapper 1260, and a spatial and frequency mapper 1280. In addition, the new transmitter structure includes an IM pilot tone mapper 1270 that is situated between the LDPC tone mapper 1260 and the spatial and frequency mapper 1280.

In the new transmitter structure, the LDPC tone mapper 1260 for the 52+26 RU size with DCM and D_{TM}=3 is used instead of the LDPC tone mapper 1220 for the 106 RU size with DCM with D_{TM} =3. Although not shown in the diagram, other transmit functional blocks (e.g., spatial and frequency mapping, pre-FEC padding, and/or post-FEC padding functional blocks) for the 52+26 RU size with DCM may be reused to support transmission in the 106 RU size with IM pilots and DCM.

The IM pilot tone mapper 1270 may map the 72 data tones defined in the (existing) tone plan for the 52+26 RU size with DCM (which may be the output from the LDPC tone mapper 1220) to 72 data tones out of the 102 data tones defined in the existing tone plan for the 106 RU size. The IM pilot tone mapper 1270 may assign the remaining 30 data tones of the 102 data tones defined in the tone plan for the 106 RU size to be IM pilot tones. The 30 IM pilot tones may be located as sparsely as possible (in the frequency domain) within the 106 RU size.

It is noted that in both the non-DCM case (shown in FIG. 10) and the DCM case (shown in FIG. 12), the resulting tone plan is the same (the resulting tone plan has 72 data tones and 30 IM pilot tones). However, in the non-DCM case, all 72 data tones carry different information (constellation symbols), whereas in the DCM case, half of the 72 data tones carry the same information (constellation symbols) as the other half.

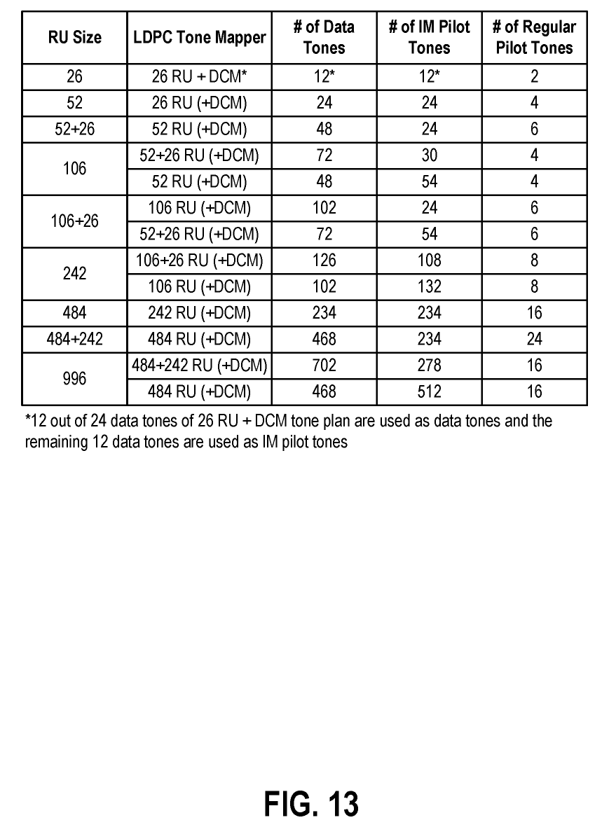

FIG. 13 is a table showing example tone plans with IM pilot tones for different RU sizes, according to some embodiments. Each row in the table specifies a tone plan with IM pilot tones for a given RU size. The table includes columns (from left to right) for the RU size, the LDPC tone mapper (or existing tone plan) that can be reused, the number of data tones in the tone plan with IM pilot tones, the number of IM pilot tones in the tone plan with IM pilot tones, and the number of regular pilot tones in the tone plan with IM pilot tones.

As shown in the diagram, for a 26 RU size, the existing tone plan for the 26 RU size with DCM can be reused. In this case, the tone plan with IM pilot tones for the 26 RU size may include 12 data tones, 12 IM pilot tones, and 2 regular pilot tones. As noted by the asterisk shown in the diagram, the existing tone plan for the 26 RU size with DCM includes 24 data tones but 12 data tones out of the total 24 data tones can be used as data tones while the remaining 12 data tones can be used as IM pilot tones.

Also, as shown in the diagram, for a 52 RU size, the existing tone plan for the 26 RU size can be reused without DCM or with DCM. In this case, the tone plan with IM pilot tones for the 52 RU size may include 24 data tones, 24 IM pilot tones, and 4 regular pilot tones.

Also, as shown in the diagram, for a 52+26 RU size, the existing tone plan for the 52 RU size can be reused without DCM or with DCM. In this case, the tone plan with IM pilot tones for the 52 RU size may include 48 data tones, 24 IM pilot tones, and 6 regular pilot tones.

Also, as shown in the diagram, for a 106 RU size, the existing tone plan for the 52+26 RU size can be reused without DCM or with DCM. In this case, the tone plan with IM pilot tones for the 106 RU size may include 72 data tones, 30 IM pilot tones, and 4 regular pilot tones. Also, for a 106 RU size, the existing tone plan for the 52 RU size can be reused without DCM or with DCM. In this case, the tone plan with IM pilot tones for the 106 RU size may include 48 data tones, 54 IM pilot tones, and 4 regular pilot tones.

Also, as shown in the diagram, for a 106+26 RU size, the existing tone plan for the 106 RU size can be reused without DCM or with DCM. In this case, the tone plan with IM pilot tones for the 106+26 RU size may include 102 data tones, 24 IM pilot tones, and 6 regular pilot tones. Also, for a 106+26 RU size, the existing tone plan for the 52+26 RU size can be reused without DCM or with DCM. In this case, the tone plan with IM pilot tones for the 106+26 RU size may include 72 data tones, 54 IM pilot tones, and 6 regular pilot tones.

Also, as shown in the diagram, for a 242 RU size, the existing tone plan for the 106+26 RU size can be reused without DCM or with DCM. In this case, the tone plan with IM pilot tones for the 242 RU size may include 126 data tones, 108 IM pilot tones, and 8 regular pilot tones. Also, for a 242 RU size, the existing tone plan for the 106 RU size can be reused without DCM or with DCM. In this case, the tone plan with IM pilot tones for the 242 RU size may include 102 data tones, 132 IM pilot tones, and 8 regular pilot tones.

Also, as shown in the diagram, for a 484 RU size, the existing tone plan for the 242 RU size can be reused without DCM or with DCM. In this case, the tone plan with IM pilot tones for the 484 RU size may include 234 data tones, 234 IM pilot tones, and 16 regular pilot tones.

Also, as shown in the diagram, for a 484+242 RU size, the existing tone plan for the 484 RU size can be reused without DCM or with DCM. In this case, the tone plan with IM pilot tones for the 484+242 RU size may include 468 data tones, 234 IM pilot tones, and 24 regular pilot tones.

Also, as shown in the diagram, for a 996 RU size, the existing tone plan for the 484+242 RU size can be reused without DCM or with DCM. In this case, the tone plan with IM pilot tones for the 996 RU size may include 702 data tones, 278 IM pilot tones, and 16 regular pilot tones. Also, for a 996 RU size, the existing tone plan for the 484 RU size can be reused without DCM or with DCM. In this case, the tone plan with IM pilot tones for the 996 RU size may include 468 data tones, 512 IM pilot tones, and 16 regular pilot tones.

The tone plans shown in the diagram are provided by way of example and not intended to limit embodiments to only these specific tone plans. It should be appreciated that other tone plans with IM pilot tones can be used in view of the concepts described in the present disclosure.

Random and unexpected interference is one of the main reasons for the limited reliability in wireless networks. Interfering signals can occupy any bandwidth – narrowband or wideband – and can originate from various sources (e.g., Wi-Fi signal originating from an overlapping basic service set (OBSS), Bluetooth signal, and 3GPP (Third Generation Partnership Project) signal in an unlicensed band). Such interference can arise at any time (e.g., in the middle of a PPDU). To mitigate such interference, a RX beamforming scheme with multiple RX antennas can be used. The solution may transmit known pilots (IM pilots) in predefined locations (tones/subcarriers) when transmitting OFDM symbols. The receiver can estimate the channel more accurately and design the RX beamforming weight based on the IM pilots. The receiver structure can be designed to perform RX beamforming based on the known IM pilot tone locations.

A transmitter structure for IM pilot insertion and various tone plans with IM pilot tones have been described herein. With the transmitter structure and the tone plans described herein, IM pilots can be inserted in wireless transmissions while reusing existing functional blocks as much as possible, which reduces implementation complexity.

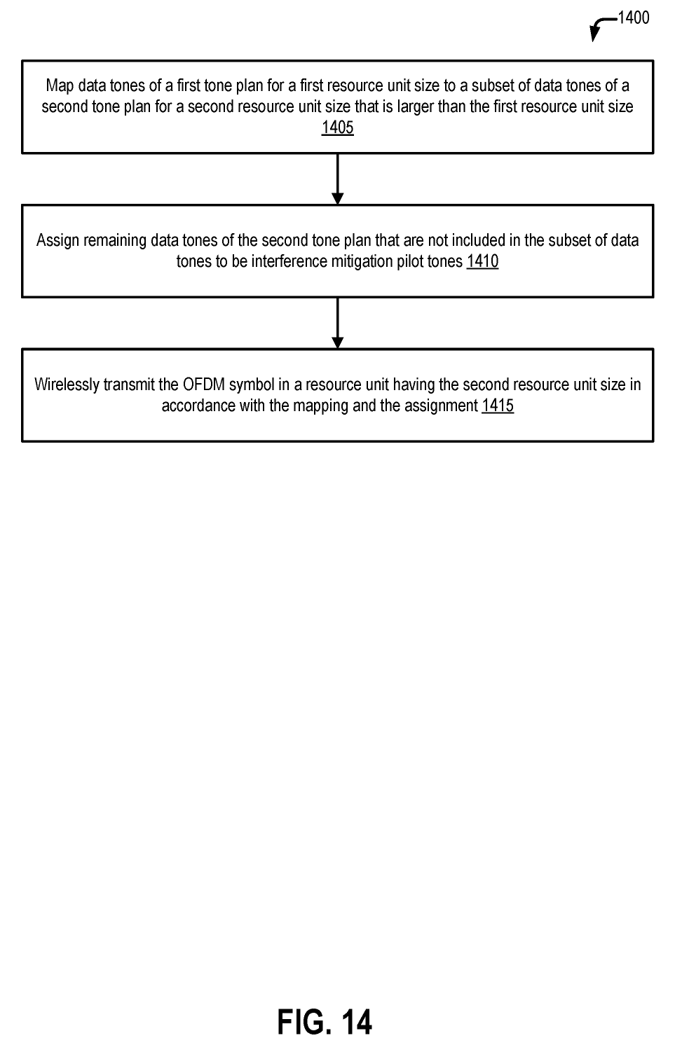

Turning now to FIG. 14, a method 1400 will be described for inserting IM pilots in a wireless transmission, in accordance with an example embodiment. The method 1400 may be performed by a wireless device (e.g., wireless device 104).

Additionally, although shown in a particular order, in some embodiments the operations of the method 1400 may be performed in a different order. For example, although the operations of the method 1400 are shown in a sequential order, some of the operations may be performed in partially or entirely overlapping time periods.

At operation 1405, the wireless device maps data tones of a first tone plan for a first resource unit size to a subset of data tones of a second tone plan for a second resource unit size that is larger than the first resource unit size. In an embodiment, the mapping of operation 1405 is performed by an interference mitigation pilot tone mapper of the wireless device that is situated between a LDPC tone mapper of the wireless device and a spatial and frequency mapper of the wireless device. In an embodiment, the LDPC tone mapper applies LDPC tone mapping using the first tone plan. In an embodiment, the LDPC tone mapper applies DCM.

At operation 1410, the wireless device assigns remaining data tones of the second tone plan that are not included in the subset of data tones to be interference mitigation pilot tones. In an embodiment, the interference mitigation pilot tones are located within the resource unit as sparsely as possible (as far apart as possible in the frequency domain).

At operation 1415, the wireless device wirelessly transmits an OFDM symbol in a resource unit having the second resource unit size in accordance with the mapping and the assignment (with interference mitigation pilot tones carrying interference mitigation pilots).

In an embodiment, the first resource unit size is a 52+26 resource unit size and the second resource unit size is a 106 resource unit size. In this embodiment, the OFDM symbol may be transmitted using 72 data tones, 30 interference mitigation pilot tones, and 4 regular pilot tones.

In an embodiment, the first resource unit size is a 52 resource unit size and the second resource unit size is a 106 resource unit size. In this embodiment, the OFDM symbol may be transmitted using 48 data tones, 54 interference mitigation pilot tones, and 4 regular pilot tones.

In an embodiment, the first resource unit size is a 484+242 resource unit size and the second resource unit size is a 996 resource unit size. In this embodiment, the OFDM symbol may be transmitted using 702 data tones, 278 interference mitigation pilot tones, and 16 regular pilot tones.

It will be appreciated that embodiments can implement any of the tone plans shown in FIG. 13 or any other tone plans with IM pilot tones that are consistent with the concepts described in the present disclosure (tone plans based on reusing existing tone plans).

An embodiment is a wireless device configured to insert interference mitigation pilots in a wireless transmission. The wireless device may include circuitry to map data tones of a first tone plan for a first resource unit size to a subset of data tones of a second tone plan for a second resource unit size that is larger than the first resource unit size and assign remaining data tones of the second tone plan that are not included in the subset of data tones to be interference mitigation pilot tones. The wireless device may further include a radio frequency transceiver to transmit an OFDM symbol in a resource unit having the second resource unit size in accordance with the mapping and the assignment. In an embodiment, the circuitry implements an interference mitigation pilot tone mapper that is situated between a LDPC tone mapper of the wireless device and a spatial and frequency mapper of the wireless device. In an embodiment, the LDPC tone mapper applies LDPC tone mapping using the first tone plan.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a wireless device to insert interference mitigation pilots in a wireless transmission, the method comprising:
mapping data tones of a first tone plan for a first resource unit size to a subset of data tones of a second tone plan for a second resource unit size that is larger than the first resource unit size;
assigning remaining data tones of the second tone plan that are not included in the subset of data tones to be interference mitigation pilot tones; and
wirelessly transmitting an orthogonal frequency division multiplexing (OFDM) symbol in a resource unit having the second resource unit size in accordance with the mapping and the assignment.

2. The method of claim 1, wherein the first resource unit size is a 52+26 resource unit size and the second resource unit size is a 106 resource unit size.

3. The method of claim 2, wherein the OFDM symbol is transmitted using 72 data tones, 30 interference mitigation pilot tones, and 4 regular pilot tones.

4. The method of claim 1, wherein the first resource unit size is a 52 resource unit size and the second resource unit size is a 106 resource unit size.

5. The method of claim 4, wherein the OFDM symbol is transmitted using 48 data tones, 54 interference mitigation pilot tones, and 4 regular pilot tones.

6. The method of claim 1, wherein the first resource unit size is a 484+242 resource unit size and the second resource unit size is a 996 resource unit size.

7. The method of claim 6, wherein the OFDM symbol is transmitted using 702 data tones, 278 interference mitigation pilot tones, and 16 regular pilot tones.

8. The method of claim 1, wherein the mapping is performed by an interference mitigation pilot tone mapper of the wireless device that is situated between a low density parity check code (LDPC) tone mapper of the wireless device and a spatial and frequency mapper of the wireless device.

9. The method of claim 8, wherein the LDPC tone mapper applies LDPC tone mapping using the first tone plan.

10. The method of claim 8, wherein the LDPC tone mapper applies dual carrier modulation (DCM).

11. The method of claim 1, wherein the interference mitigation pilot tones are located within the resource unit as sparsely as possible.

12. A wireless device configured to insert interference mitigation pilots in a wireless transmission, the wireless device comprising:
circuitry operable to map data tones of a first tone plan for a first resource unit size to a subset of data tones of a second tone plan for a second resource unit size that is larger than the first resource unit size and assign remaining data tones of the second tone plan that are not included in the subset of data tones to be interference mitigation pilot tones; and
a radio frequency transceiver to wirelessly transmit an orthogonal frequency division multiplexing (OFDM) symbol in a resource unit having the second resource unit size in accordance with the mapping and the assignment.

13. The wireless device of claim 12, wherein the first resource unit size is a 52+26 resource unit size and the second resource unit size is a 106 resource unit size.

14. The wireless device of claim 13, wherein the OFDM symbol is transmitted using 72 data tones, 30 interference mitigation pilot tones, and 4 regular pilot tones.

15. The wireless device of claim 12, wherein the first resource unit size is a 52 resource unit size and the second resource unit size is a 106 resource unit size.

16. The wireless device of claim 15, wherein the first resource unit size is a 484+242 resource unit size and the second resource unit size is a 996 resource unit size.

17. The wireless device of claim 16, wherein the OFDM symbol is transmitted using 702 data tones, 278 interference mitigation pilot tones, and 16 regular pilot tones.

18. The wireless device of claim 12, wherein the circuitry implements an interference mitigation pilot tone mapper that is situated between a low density parity check code (LDPC) tone mapper of the wireless device and a spatial and frequency mapper of the wireless device.

19. The wireless device of claim 18, wherein the LDPC tone mapper applies LDPC tone mapping using the first tone plan.

20. The wireless device of claim 19, wherein the interference mitigation pilot tones are located within the resource unit as sparsely as possible.
